(19) United States
(12) Patent Application Publication
(10) Pub. No.: US 2004/0095885 A1
(43) Pub. Date: May 20, 2004

(54) Priority queuing method and apparatus

(75) Inventor: Myung-Hoon Yang, Seoul (KR)

Correspondence Address: Steven M. Mills, MILLS & ONELLO LLP, Suite 605, Eleven Beacon Street, Boston, MA, 02108, US

(73) Assignee: Samsung Electronics Co., Ltd.

(21) Appl. No.: 10/641,932

(22) Filed: Aug. 15, 2003

(30) Foreign Application Priority Data
Nov. 15, 2002 (KR) 02-71245

(51) Int. Cl. H04L 12/28

(52) U.S. Cl. 370/235.1

(57) ABSTRACT

A priority queuing apparatus and method for transmitting packets according to priority order of a packet are disclosed. The probability for selecting the output queue may vary according to the priority order of the output queue by means of the weighted linear feedback shift register (LFSR) employing a small number of flip flops and simple logic gates. In addition, the probability for selecting the output queue may be inversely proportional to the packet length by means of the weighted LFSR. The priority order of a packet may be reflected stochastically in the priority queuing operation by means of simple hardware configuration, and the packet length may be reflected in the priority queuing operation by means of simple hardware configuration.

### CROSS-REFERENCE TO RELATED APPLICATIONS

The application relies for priority upon Korean Patent Application No.2002-71245 filed on Nov. 15, 2002, the contents of which are herein incorporated by reference in their entirety.

### BACKGROUND OF THE INVENTION

1. Field of the Invention

The invention relates a priority queuing method and a priority queuing system for a packet-based communication network, and more particularly to a priority queuing method and a priority queuing system that determine the priority order of the packet to be transmitted.

2. Description of the Related Art

A communication network device for processing packets such as an Ethernet switch analyzes priority information in a packet, and allocates a high bandwidth for a packet having a high priority order and a low bandwidth for a packet having a low priority order. Specifically, the Ethernet switch provides a plurality of output queues corresponding to priorities, and a high priority order is allocated to an output queue having a high priority.

Generally, two methods have been proposed to allocate the priority order to each of the output queues. First, in a strict priority queuing (SPQ) method, a packet in the output queue having the highest priority order is transmitted. Second, in a weighted fair queuing (WFQ) method, different weights are allocated to each of the output queues according to the priority order.

FIG. 1 is a block diagram showing a general Ethernet switch. Referring to FIG. 1, the Ethernet switch includes a lookup table 10, an address lookup 20, a queue manager 30, a memory manager 40, a packet memory 50 and port controllers 60.

A port controller 60 checks whether or not received packets have errors and extracts an address field from each of the received packets to send the address field to the address lookup 20. The port controller 60 stores the received packets in the packet memory 50 through the memory manager 40, reads out packets to be transmitted from the packet memory 50 and outputs the read packet.

The address lookup 20 analyzes a destination address (DA) and a source address (SA) of the received packets, establishes the lookup table 10 and determines to which port the received packets are transmitted.

The queue manager 30 controls the transmission order of the packets to be transmitted to each of the ports by considering the order in which the packets are received and the priority order of the packets.

The memory manager 40 manages the packet memory 50 in which the packets are stored.

In the general Ethernet switch, when a port receives packets, the received packets are stored in the packet memory 50. The Ethernet switch analyzes a packet address field of the received packets and determines the port to which the received packets are transmitted. In addition, once the port to which the received packets are transmitted is determined, the Ethernet switch reads the packets from the packet memory 50 and transmits the read packet to the port to which the received packets are transmitted.

In an Ethernet switch that does not consider the priority order of packets, the queue manager 30 establishes only one output queue coupled to an output port, and the first inputted packet is first transmitted regardless of the priority order of the packets.

However, in an Ethernet switch that considers the priority order of packets, once an output port to which the received packets are transmitted is determined, the queue manager 30 establishes a plurality of output queues coupled to the determined output port, and the number of the output queues is the same as the level of priority orders of packets.

Since an output port is coupled to a plurality of output queues, the Ethernet switch should decide an output queue that has a packet to be transmitted. A strict priority queuing technique and a weighted fair queuing technique have been proposed.

FIG. 2 is a schematic view showing a conventional strict priority queuing (SPQ) system. Referring to FIG. 2, the conventional strict priority queuing system transmits a packet in an output queue having the highest priority order among a plurality of output queues 220 (queue n, queue n−1, queue n−2, . . . , queue 0) having packets to be transmitted. The SPQ system employs output queue scheduler 200 implemented with a priority encoder. The packet in the output queue having a high priority order is always transmitted prior to the packet in the output queue having a low priority order. The SPQ system has the advantage that the SPQ system may be implemented simply.

The output queue scheduler 200 receives information about output queues in which a packet to be transmitted exists, determines an output queue having the highest priority order, and transmits the packet in the output queue having the highest priority order. Accordingly, the output queue scheduler may be implemented with a simple priority encoder and a simple logic circuit.

However, in the SPQ system, even when a packet remains in an output queue having high priority order, packets in output queues having low priority order cannot be transmitted. Accordingly, when packets having high priority order are received continuously, packets in output queues having low priority order may be abandoned or dropped.

Although the Ethernet switch does not abandon packets having a low priority order, if a packet does not arrive at a destination address during predetermined period, the packet can no longer be used. This is especially true when a user having a high priority order continuously transmits packets the number of which is greater than the bandwidth allocated to the output port, since in this case packets in output queues having low priority order may be transmitted only after the user having high priority order stops transmitting packets. The SPQ system may be simply implemented in hardware, but there is a problem that packets having a low priority order cannot be transmitted and may be abandoned.

The WFQ system has been proposed so as to solve the problem of the SPQ system.

FIG. 3 is a schematic view showing a weighted fair queuing (WFQ) system. Referring to FIG. 3, an output queue scheduler 300 in the WFQ system includes a packet counter n, packet counter n−1, packet counter n−2, . . . , packet counter 0 and an output queue selecting section 314. The packet counter n, packet counter n−1, packet counter n−2, . . . , and packet counter 0 are coupled to each of the output queues, i.e., an output queue n (320-n), output queue n−1 (320-(n−1)), output queue n−2 (320-(n−2)), . . . , output queue 0 (320-0), respectively. The output queue selecting section 314 is coupled to the packet counters.

The output queue scheduler 300 in the WFQ system accords different weights to the output queues (320-n, 320-(n−1), 320-(n−2), . . . , 320-0). A high weight is accorded to an output queue having a high priority, and a low weight is accorded to an output queue having a low priority. In addition, the output queue scheduler 300 selects output queues considering the weights by means of a round robin algorithm.

For instance, it is assumed that a weight n is 4 and weight 0 is 1, a packet counter counts the number of transmitted packets for each of the output queues, and the output queue selecting section 314 controls the packet transmission rate such that the output queue 0 (320-0) having a weight value of 1 transmits one packet whenever the output queue n (320-n) having a weight value of 4 transmits four packets.

In the WFQ system, the packet counter counts the number of transmitted packets for each of the output queues, and selects an output queue to transmit packet at the present time based on the number of transmitted packets. Since the number of output queues is proportional to the increase in the number of priority order, the number of counters increases, so that the logic circuit for selecting the output queue becomes complicated.

In addition, even in the WFQ system, the bandwidth cannot be exactly allocated to the packets according to the priority order. Since the bandwidth is allocated to the packets based on the number of the packets and the packets have different packet lengths, the bandwidth may not be exactly allocated to the packets.

For example, it is assumed that a first output queue to which a weight value of 1 is accorded includes a first packet having 256 bytes and a second output queue to which a weight value of 2 is accorded includes a second packet having 64 bytes, when the first and second packets are transmitted in the WFQ system, the bandwidth allocated to the first packet of the first output queue accorded a weight value of 1 is two times the bandwidth allocated to the second packet of the second output queue accorded a weight value of 2.

Accordingly, the bandwidth can be allocated more exactly to the packets based on the number of data bits of a packet rather than based on number of the packets. In other words, an output queue accorded a highest weight transmits a predetermined number of data bits, then an output queue accorded a second high weight transmits a predetermined number of data bits, and so on. After all data bits of one packet are transmitted completely, the next packet in a next output queue should be transmitted.

The WFQ system can solve the problem that a packet of a low priority order is abandoned in the SPQ system. However, counters are used for each of the output queues, and the hardware complexity increases in proportion to the number of the priority order levels.

In addition, when the bandwidth is allocated based only on the number of the packets, the bandwidth cannot be exactly allocated to the packets because of the difference of the packet length. The hardware configuration may be complex when the bandwidth is allocated to the packets based on amount of data.

When the WFQ system counts the number of the data bits to be transmitted rather than the number of packets to be transmitted, the bandwidth may be relatively exactly allocated to the packets because the priority queuing operation is performed based on the packet length, but there is a disadvantage that the hardware configuration of the WFQ system is complex.

### SUMMARY OF THE INVENTION

Accordingly, the present invention is provided to substantially obviate one or more problems due to limitations and disadvantages of the related art.

It is a first feature of the present invention to provide a priority queuing method in which a priority queuing operation may be performed under a simple hardware configuration.

It is a second feature of the present invention to provide a priority queuing method in which a priority queuing operation may be performed using a simple hardware configuration and by considering not only priority order of the packets but also the packet length when allocating the bandwidth to the packets.

It is a third feature of the present invention to provide a priority queuing apparatus that has simple hardware configuration.

It is a fourth feature of the present invention to provide a priority queuing apparatus that has simple hardware configuration and considers not only priority order of the packets but also the packet length when allocating the bandwidth to the packets.

To accomplish the first feature of the present invention, there is provided a priority queuing method. According to the priority queuing method, priority weights are produced, each of the priority weights has a probability for selecting each of a plurality of output queues, and the probability corresponds to a priority order of each of the output queues. One of the output queues is selected based on the priority weights, and a packet is outputted from the selected output queue.

To accomplish the second feature of the present invention, there is provided another priority queuing method. According to the priority queuing method, priority weights are produced, each of the priority weights has a probability for selecting each of a plurality of output queues, and the probability corresponds to a priority order of each of the output queues. A packet-length level is produced based on packet length information of a packet stored in each of the output queues. Packet-length weights are produced based on the packet-length level so as to increase a probability for selecting the packet. The probability is substantially inversely proportional to the packet length of the packet. One of the output queues is selected by considering the priority order of each of the output queues and the packet length of the packet stored in each of the output queues based on the priority weights and the packet-length weights. A packet is outputted from the selected output queue.

To accomplish the third feature of the present invention, there is provided a priority queuing apparatus for selecting one of priority queues based on a priority order of each of the output queues. The apparatus comprises a priority-weight allocating section, an output queue selecting section and a packet outputting section. The priority-weight allocating section produces priority weights, each of the priority weights has a probability for selecting each of a plurality of output queues, and the probability corresponds to a priority order of each of output queues. The output queue selecting section generates an output-queue selecting signal for selecting one of the output queues based on the priority weights. The packet outputting section outputs a packet from the output queue selected by using the output-queue selecting signal.

To accomplish the fourth feature of the present invention, there is provided a priority queuing apparatus for selecting one of priority queues based on a priority order of each of the output queues. The apparatus comprises a priority-weight allocating section, a packet-length level calculating section, a packet-length weight allocating section, an output queue selecting section and a packet outputting section. The priority-weight allocating section produces priority weights, each of the priority weights has a probability for selecting each of a plurality of output queues, and the probability corresponds to a priority order of each of output queues. The packet-length level calculating section produces a packet-length level based on packet length information of a packet stored in each of the output queues. The packet-length weight allocating section produces packet-length weights based on the packet-length level so as to increase a probability for selecting the packet, and the probability is substantially inversely proportional to a packet length of the packet. The output queue selecting section generates an output-queue selecting signal for selecting one of the output queues in correspondence to the priority order of each of the output queues and the packet length of the packet stored in each of the output queues based on the priority weights and the packet-length weights. The packet outputting section outputs a packet from the output queue selected by using the output-queue selecting signal.

According to the present invention, the probability for selecting the output queue may be varied according to the priority order of the output queue by means of the weighted linear feedback shift register (LFSR). In addition, the probability for selecting the output queue may be inversely proportional to the packet length by means of the weighted LFSR.

In addition, since a weighted LFSR employs a small number of flip flops and simple logic gates, a highly efficient priority queuing operation may be performed by means of simple hardware configuration.

In addition, the priority order of the packet to be transmitted may be reflected stochastically without considering the number of the packets to be transmitted in the priority queuing operation by means of a simple hardware configuration.

In addition, not only the priority order of the packets but also the packet length may be reflected in the priority queuing operation by means of a simple hardware configuration.

### BRIEF DESCRIPTION OF THE DRAWINGS

The foregoing and other objects, features and advantages of the invention will be apparent from the more particular description of a preferred embodiment of the invention, as illustrated in the accompanying drawings in which like reference characters refer to the same parts throughout the different views. The drawings are not necessarily to scale, emphasis instead being placed upon illustrating the principles of the invention.

FIG. 1 is a block diagram showing a general Ethernet switch.

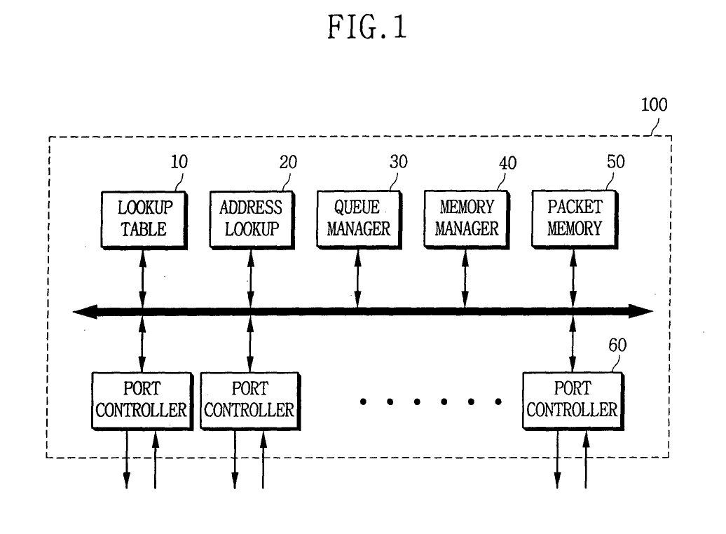

FIG. 2 is a schematic view showing a conventional strict priority queuing (SPQ) system.

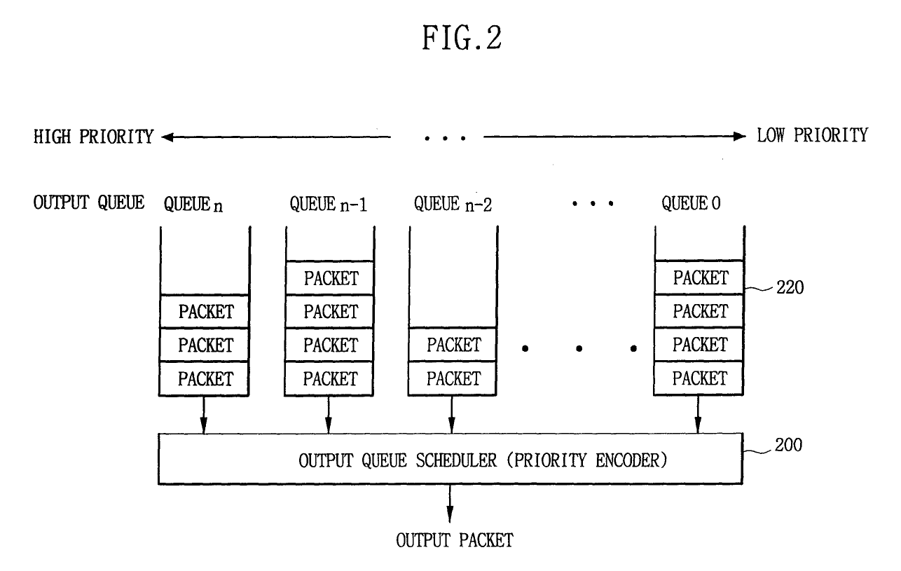

FIG. 3 is a schematic view showing a weighted fair queuing (WFQ) system.

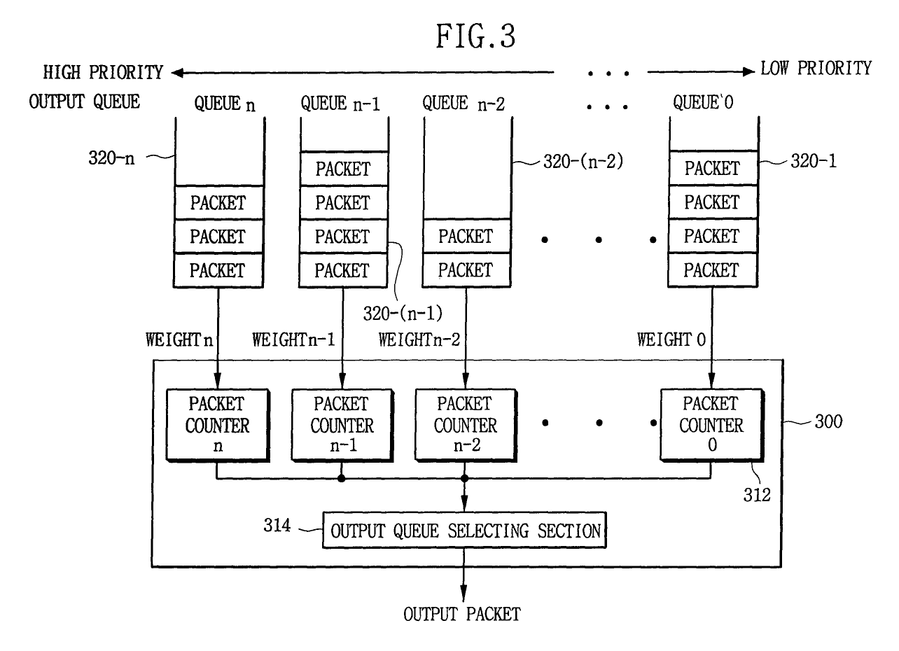

FIG. 4 is a schematic view showing a priority queuing system using a weighted linear feedback shift register according to one exemplary embodiment of the present invention.

FIG. 5 is a block diagram showing an output queue scheduler of FIG. 4.

FIG. 6 is a block diagram showing an exemplary output queue scheduler of FIG. 5.

FIG. 7 is a block diagram showing a general linear feedback shift register (LFSR).

FIG. 8 is a block diagram showing a weighted linear feedback shift register (weighted LFSR).

FIG. 9 is a block diagram showing a priority queuing method using a weighted linear feedback shift register according to another exemplary embodiment of the present invention.

FIG. 10 is a block diagram showing an exemplary output queue scheduler of FIG. 9.

FIG. 11 is a block diagram showing a priority queuing method considering a priority of the output queues and a packet length using a weighted linear feedback shift register when output queues have four priority order levels.

FIG. 12 is a flow chart illustrating a priority queuing method using a weighted linear feedback shift register according to one exemplary embodiment of the present invention.

### DETAILED DESCRIPTION OF THE PREFERRED EMBODIMENTS

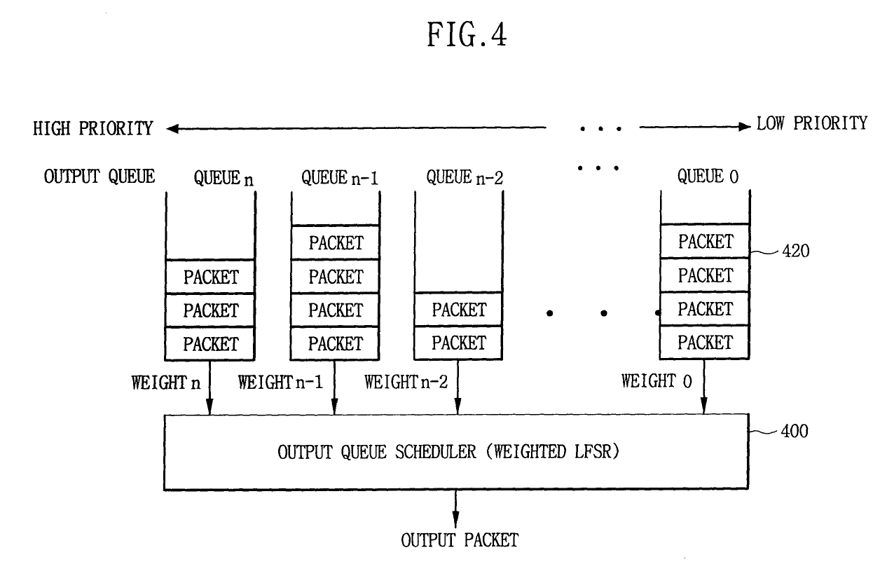

FIG. 4 is a schematic view showing a priority queuing system using a weighted linear feedback shift register (weighted LFSR) according to one exemplary embodiment of the present invention.

Referring to FIG. 4, an output queue scheduler 400 selects the output queues having different priority orders by allocating different probabilities to the output queues having different priority orders. In the conventional WFQ system the number of the packets to be transmitted is counted by means of counters so as to select an output queue. This is the difference between the priority queuing method according to the present invention and the conventional WFQ system. The priority queuing apparatus according to the present invention employs a linear feedback shift resister having a simple hardware configuration and a simple logic circuit so that the hardware configuration of the priority queuing apparatus may be simpler compared with the conventional WFQ system employing a plurality of counters.

For example, the conventional WFQ system transmits four packets in the output queue having a weight value of 4, and then transmits one packet in the output queue having a weight value of 1. The priority queuing apparatus according to the present invention does not consider the number of the packets that are transmitted in the output queues. However, according to the priority queuing apparatus of the present invention, the probability for transmitting the packet accorded a weight value of 4 at the present time is four times the probability for transmitting the packet accorded a weight value of 1.

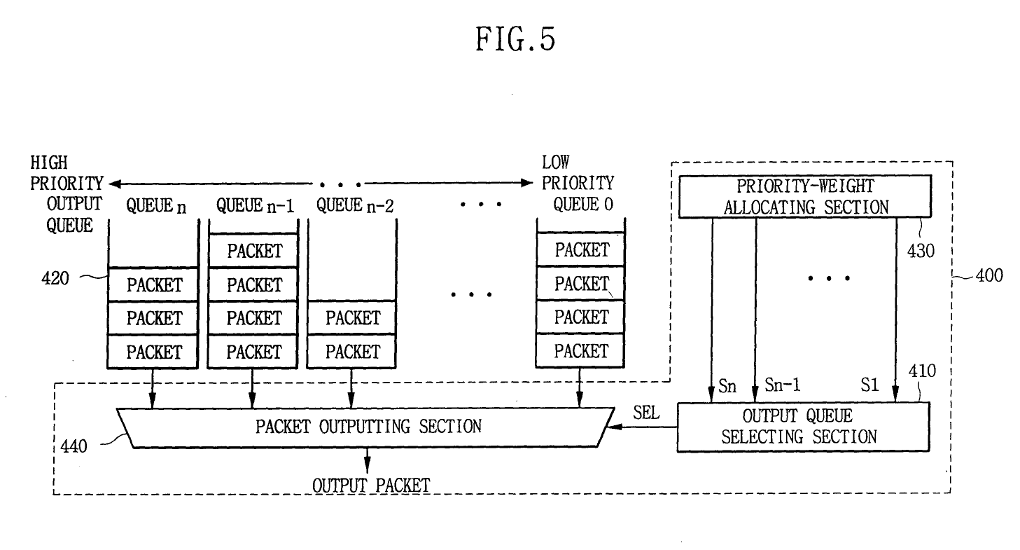

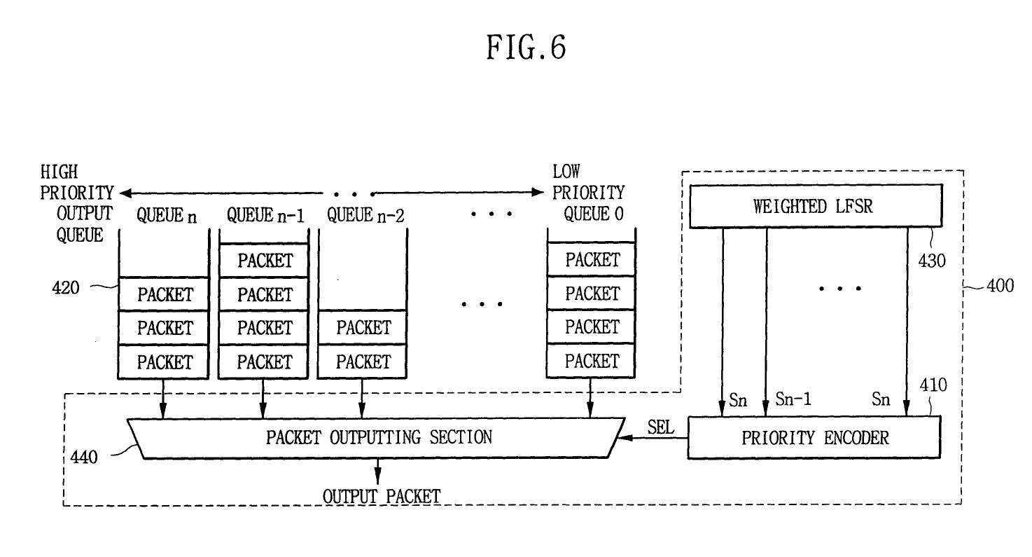

FIG. 5 is a block diagram showing an output queue scheduler of FIG. 4, and FIG. 6 is a block diagram showing an exemplary output queue scheduler of FIG. 5.

Referring to FIG. 5, the output queue scheduler 400 includes a priority-weight allocating section 430, an output queue selecting section 410 and a packet outputting section 440.

The priority-weight allocating section 430 outputs priority weights (Sn, Sn−1, . . . , S1) that have a probability for selecting the output queues according to the priority order of the output queue. Preferably, the priority-weight allocating section 430 outputs the priority weights (Sn, Sn−1, . . . , S1) that have a probability for selecting the output queues in proportion to the priority order of the output queue. That is, the probability for selecting the output queue having a high priority order is higher than the probability for selecting the output queue having a low priority order.

The priority-weight allocating section 430 may be implemented by means of a simple hardware configuration such as a weighted LFSR shown in FIG. 6. Detailed description of the linear feedback shift register (LFSR) and the weighted LFSR will follow.

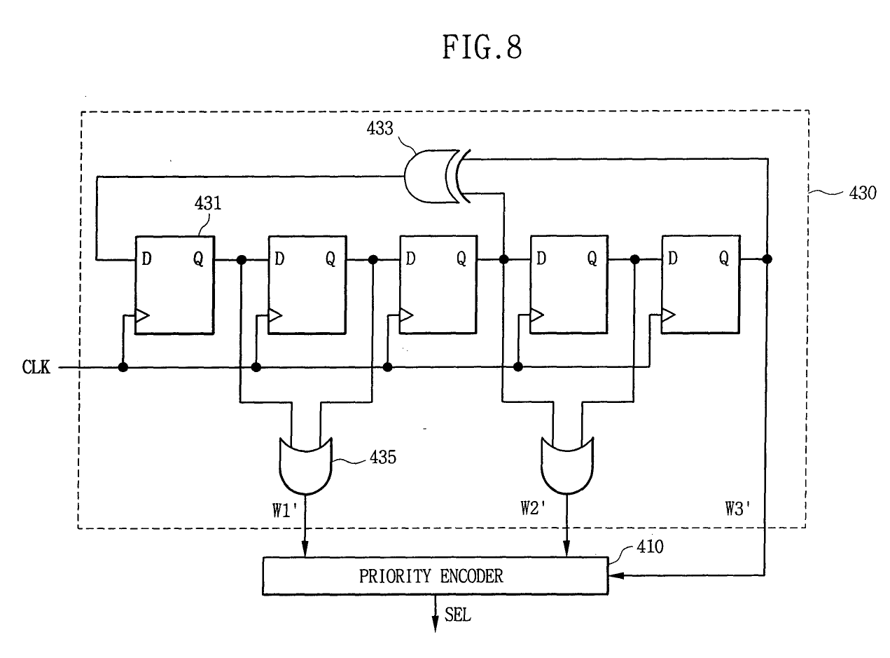

The output queue selecting section 410 generates output queue selecting signal (SEL) using the priority weights (Sn, Sn−1, . . . , S1). The output queue selecting section 410 may generate the output queue selecting signal (SEL) by means of a priority encoder shown in FIG. 6. The detailed process of generating the output queue selecting signal (SEL) by means of a priority encoder will be described in connection with FIG. 8.

The packet outputting section 440 considers the priority order of a plurality of output queues 420 and outputs packets from the output queues 420 using the output queue selecting signal (SEL).

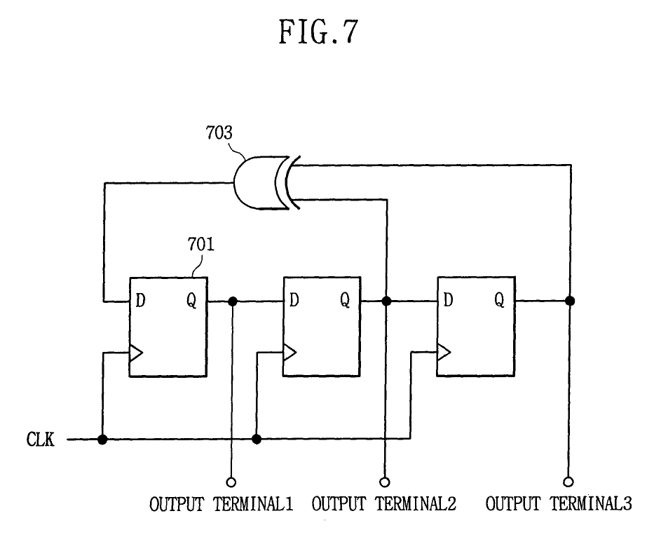

FIG. 7 is a block diagram showing a general linear feedback shift register (LFSR), and FIG. 8 is a block diagram showing a weighted linear feedback shift register (weighted LFSR).

Referring to FIG. 7, the LFSR includes a shift register having a small number of flip flops 701. The outputs of some flip flops are fed back to an input terminal of the exclusive-OR gate (XOR) 703.

The LFSR outputs data bits of logical ‘0’ or ‘1’ in a probability of ½ in random sequence through output terminals 1, 2 and 3. In other word, the LFSR generates a pseudo-random pattern.

The LFSR has an effective structure due to a simple hardware configuration. The LFSR generates the pseudo-random pattern successively by itself when an initial value (or seed) is inputted thereto and an external clock signal (CLK) is inputted thereto. When the initial value is binary bits ‘111’, pseudo-random patterns such as {‘111’, ‘011’, ‘001’, ‘100’, ‘010’, ‘101’, ‘110’, ‘110’} are generated and are outputted through the output terminals. Seven bit patterns except bit pattern ‘000’ are generated in random sequence without predetermined rules. When the LFSR operates continuously, the seven pseudo-random patterns are repeatedly generated in succession.

Hereinafter, the weighted LFSR is referred to as an LFSR to which simple logic gates are added. The weighted LFSR outputs data bit of bit ‘0’ or ‘1’ in an arbitrary probability other than ½.

Referring to FIG. 8, the weighted LFSR 430 includes a LFSR and simple logic gates such as OR gate 435. The weighted LFSR 430 includes small number of flip flops and simple circuit such as logic gates and can generate pseudo-random patterns with relatively high efficiency.

The weighted LFSR 430 operates each of the output bits of the LFSR by means of logic gates having AND gates or OR gates, etc., Each of ‘0’ or ‘1’ bit of the pseudo-random patterns comprised of ‘0’ or ‘1’ bit streams are generated in a desired probability. Therefore, the weighted LFSR can generate the output queue selecting signal (SEL).

For example, when an AND operation is performed for two bits each of which outputs ‘1’ in a probability of ½ by means of the AND gate, the resultant bit after the AND operation outputs ‘1’ in a probability ¼. When an OR operation is performed for two bits each of which outputs ‘1’ in a probability of ½ by means of the OR gate, the resultant bit after the OR operation outputs ‘1’ in a probability ¾. In the weighted LFSR system, when the pseudo-random patterns comprised of ‘0’s or ‘1’s are generated, the probability of ‘0’ or ‘1’ is not only ½ but also ¼, ¾, . . . , etc according to the combination of logic gates.

Each of the output queues can be selected in different probabilities in accordance with the priority order thereof in the weighted LFSR system. Preferably, an output queue accorded a high priority order is selected in high probability, and an output queue accorded a low priority order is selected in low probability.

Therefore, the packet accorded a high priority order is transmitted in higher probability at the present time than the packet accorded a low priority order. As a result, large bandwidth is allocated to the packet accorded a high priority order. In addition, since the transmission probability for the packet accorded a low priority order is not zero, the disadvantage of dropped low-priority packets in the conventional SPQ system does not occur. In addition, since the LFSR has a relatively small hardware size, the disadvantage of the conventional weighted LFSR system due to the complexity of hardware configuration can be overcome. Hereinafter, the weighted LFSR according to the present invention is described.

Referring again to FIG. 8, the weighted LFSR 430 considers 4 levels of priority order such as 0, 1, 2, 3. The weighted LFSR 430 generates priority weights W1′, W2′, W3′. The W3′ has ‘1’ in probability of ½. The W1′ and W2′ have ‘1’ in probability of ¾ because an OR operation is performed for two signals each of which has ‘1’ in probability of ½ by means of an OR gate 435.

The output queue selecting signal (SEL) is used for selecting the output queues, the signal (SEL) is generated by the following rule. When W3′ is ‘1’, the output (SEL) of the priority encoder is ‘11’, and an output queue accorded priority order level 3 is selected by the SEL signal. When W3′ is ‘0’ and W2′ is ‘1’, the output (SEL) of the priority encoder is ‘10’, and an output queue accorded priority order level 2 is selected by the SEL signal. When W3′ is ‘0’, W2′ is ‘0’ and W1′ is ‘1’, the output (SEL) of the priority encoder is ‘01’, and an output queue accorded priority order level 1 is selected by the SEL signal. When W3′ is ‘0’, W2′ is ‘0’ and W1′ is ‘0’, the output (SEL) of the priority encoder is ‘00’, and an output queue accorded priority order level 0 is selected by the SEL signal. The probabilities for each output signal (SEL) of the priority encoder are as follows.

i) P(SEL=“11”)=½=50%

ii) P(SEL=“10”)=½*¾=⅜=37.5%

iii) P(SEL=“01”)=½*¼*¾=3/32=9.375%

iv) P(SEL=“00”)=½*¼*¼=1/32=3.125%

When it is assumed that the packet length is constant, 50% of the total bandwidth is allocated to the packet accorded the highest priority order, 3.125% of the total bandwidth is allocated to the packet accorded the lowest priority order.

In order that bandwidth be allocated to the packet in proportion to the priority of the packet, the logic gate for the output bit of the LFSR may be changed so that the probability of ‘1’ in W3′ signal increases. In order that the amount of bandwidth is regulated for each of the priority orders, the logic gate for the output bit of the LFSR may be changed so that a desired bandwidth may be allocated to the packets.

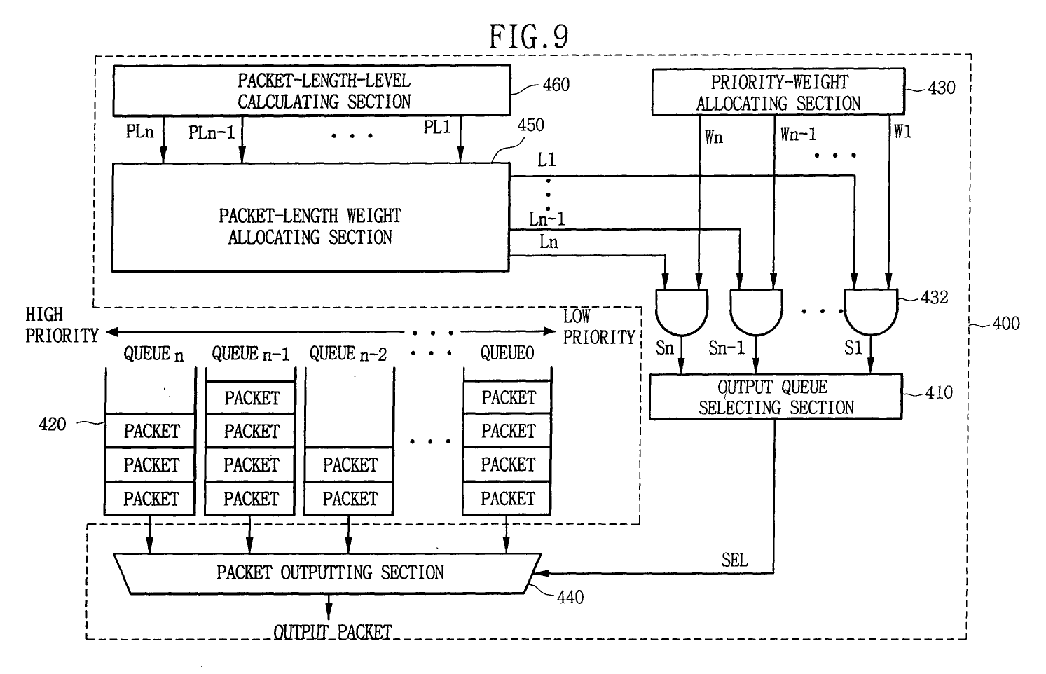

FIG. 9 is a block diagram showing a priority queuing approach using a weighted linear feedback shift register according to another exemplary embodiment of the present invention. Referring to FIG. 9, the output queue scheduler 400 includes a priority-weight allocating section 430, a packet-length-level calculating section 460, a packet-length weight allocating section 450, an output queue selecting section 410 and a packet outputting section 440.

The priority-weight allocating section 430 generates priority-weights (Wn, Wn−1, . . . , W1) each of which has probability for selecting the output queues in proportion to the priority order level of the output queues.

The priority-weight allocating section 430 may be implemented by means of the weighted LFSR.

The packet-length-level calculating section 460 and the packet-length weight allocating section 450 are employed so that the weights may be allocated based on priority orders of the packets and the packet length.

The packet-length-level calculating section 460 divides the packet length into n levels to output packet length levels (PLn, PLn−1, . . . , PL1). Preferably, the ‘n’ may be the same as the number of the priority order levels. In other words, when the priority order level is ‘n’, the packet length can be divided into five levels.

The packet-length-level calculating section 460 extracts packet length information from the header of the packets and calculates packet length level from binary bit stream indicating packet length by a simple bit operation.

For example, the packet-length-level calculating section 460 outputs a binary value ‘11’ for packet length equal to or more than 1024 bytes, a binary value ‘10’ for packet length between 1024 bytes and 256 bytes, a binary value ‘01’ for packet length between 256 bytes and 64 bytes, and a binary value ‘00’ for packet length of less than 64 bytes. In the above example, four levels of packet length are used.

For example, when the binary value indicating the packet length is ‘11 0001 0100’, the packet-length-level calculating section 460 concludes that the packet length is more than 1024 bytes by checking the upper most bit value (‘1’) in the binary bit stream indicating the packet length and outputs a binary value ‘11’. In addition, when the binary value indicating the packet length is ‘00 0100 0011’, the packet-length-level calculating section 460 concludes that the packet length is more than 64 bytes by checking the 7^{th} bit value (‘1’) in the binary bit stream indicating the packet length and outputs a binary value ‘01’.

The packet-length weight allocating section 450 receives the packet-length-levels (PLn, PLn−1, . . . , PL1), decide weights according to the packet length and outputs packet-length weight (Ln, Ln−1, . . . , L1). Preferably, the packet-length weight (Ln, Ln−1, . . . , L1) has probability inversely proportional to the packet length.

The output queue selecting section 410 generates output queue selecting signal (SEL) using the priority weights (Wn, Wn−1, . . . , W1) and the packet-length weights. For example, an AND operation is performed on the priority weights (Wn, Wn−1, . . . , W1) and the packet-length weights, and then the output queue selecting signal (SEL) is generated by a priority encoder.

The packet outputting section 440 receives the output queue selecting signal (SEL), and outputs packets from the plurality of output queues 420 by considering the priority order and the packet length based on the output queue selecting signal (SEL).

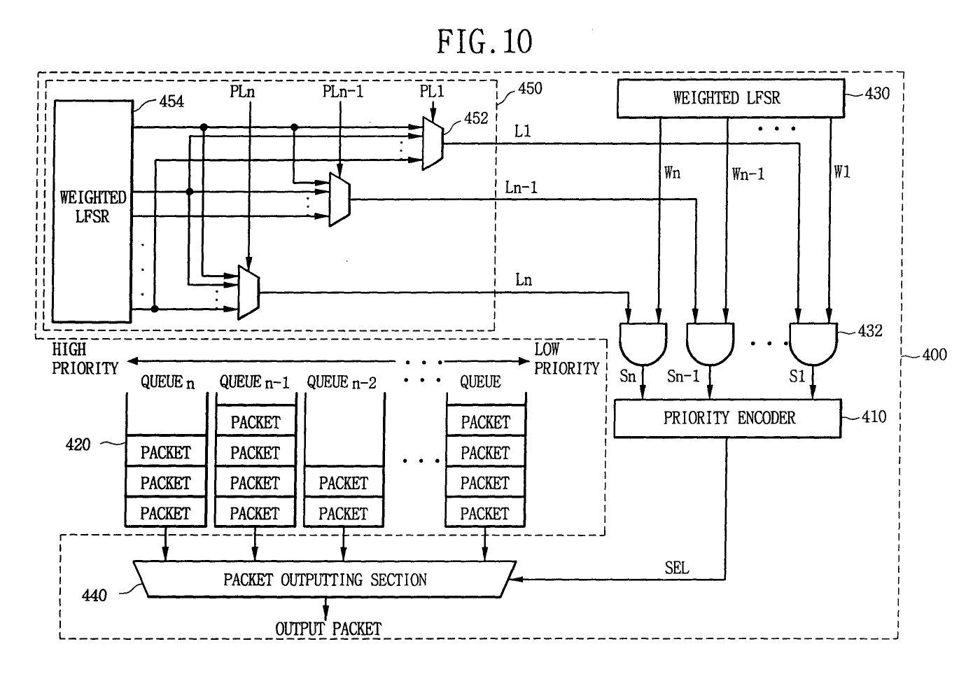

FIG. 10 is a block diagram showing an exemplary output queue scheduler of FIG. 9. Referring to FIG. 10, the output scheduler 400 includes a packet-length weight allocating section 450, a weighted LFSR 430, a plurality of AND gates 432 that perform an AND operation for the output of the packet-length weight allocating section 450 and the output of the weighted LFSR 430, and an priority encoder 410.

The weighted LFSR 430 generates a plurality of pseudo-random patterns of which bit values may have different probabilities from each other, and outputs priority weights (Wn, Wn−1, . . . , W1). The priority weights (Wn, Wn−1, . . . , W1) generated by the weighted LFSR 430 have probability for selecting the output queues proportional to the priority order of the output queue.

When the pseudo-random patterns comprised of ‘0’ or ‘1’ are generated, the pseudo-random pattern of which that has the highest probability of ‘1’ is used as a selection signal for selecting the output queue accorded the highest priority order, but the pseudo-random pattern of which that has the lowest probability of ‘1’ is used as a selection signal for selecting the output queue accorded the lowest priority order. For example, when m priority order levels are used, the weighted LFSR 430 generates m−1 random signals. A priority order level n is selected when Wn is ‘1’, a priority order level n−1 is selected when Wn is ‘0’ and Wn−1 is ‘1’. A priority order level 0 is selected when Wn˜W1 are all ‘0’.

According to the present invention, the packet length is reflected in calculating the probability for selecting the output queues by means of simple hardware. That is, the length of a packet is divided into a plurality of levels, a packet having a long length is selected so as to be transmitted in a low probability, and a packet having a short length is selected so as to be transmitted in a high probability. In addition, when the AND operation is performed on a selecting value (priority weights) corresponding to the priority order and the packet-length weight, and then the output queue selecting signal is generated, the amount of data packets is reflected in allocating the bandwidth to the packets.

The packet-length weight allocating section 450 includes a weighted LFSR 454 and a plurality of multiplexers 452. The multiplexers 452 are connected to the outputs of the weighted LFSR 454.

The packet-length weight selecting section 450 generates a plurality of random values having different probabilities from each other by means of the weighted LFSR 454. The random outputs of the weighted LFSR 454 are inputted to the multiplexers 452, packet-length-levels (PLn, PLn−1, . . . , PL1) are inputted to the multiplexers 452 so as to control the output of the multiplexers 452. Accordingly, the mulitplexers 452 output the packet-length weights (Ln, Ln−1, . . . , L1). Preferably, the packet-length weight (Ln, Ln−1, . . . , L1) has probability inversely proportional to the packet length.

Sn˜S1 are generated through the AND operation performed on the random values (Wn, Wn−1, . . . , W1) reflecting the priority of the output queue and the packet-length weights (Ln, Ln−1, . . . , L1) reflecting the length of packets.

The priority encoder 410 receives Sn˜S1 and outputs output queue selecting signals (SEL) using the Sn˜S1 so as to select an output queue to be transmitted. The Sn˜S1 has probability of ‘1’, and the probability of ‘1’ is proportional to the priority order and inversely proportional to the packet length.

For example, an output of the priority encoder is n when Sn is ‘1’, an output of the priority encoder is n−1 when Sn is ‘0’ and Sn−1 is ‘1’, an output of the priority encoder is 1 when Sn˜S2 are all ‘0’ and S1 is ‘1’, and an output of the priority encoder is 0 when Sn˜S1 are all ‘0’.

The packet outputting section 440 may be implemented by means of multiplexers. It receives the output queue selecting signal (SEL), which is the output of the priority encoder, as a control signal for the multiplexer, selects an output queue, and transmits packets from the selected output queue.

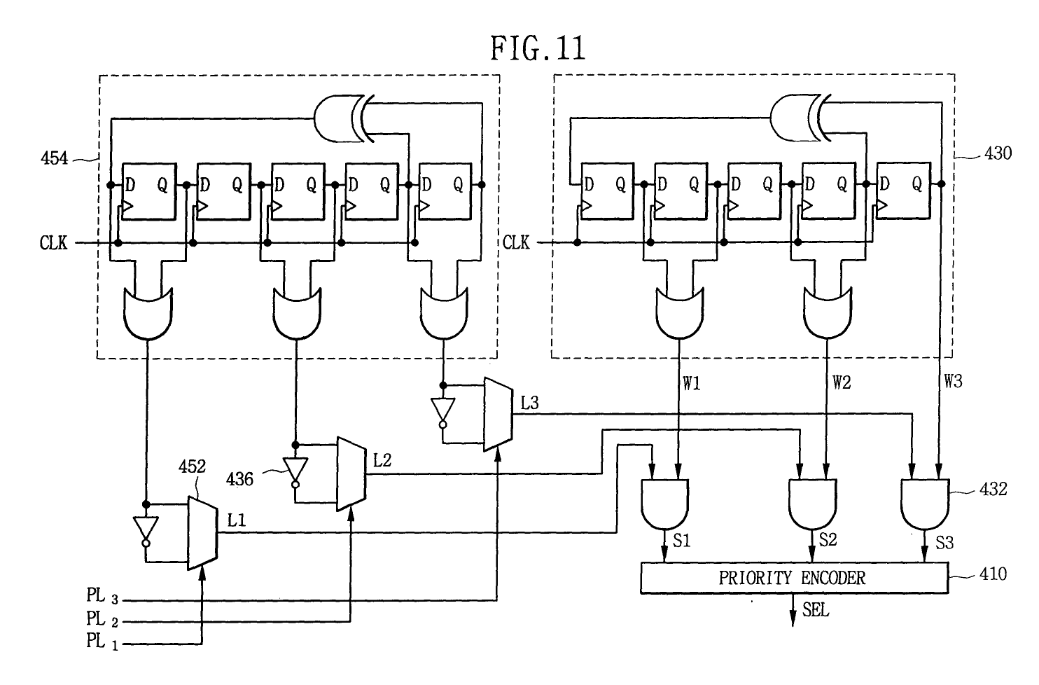

FIG. 11 is a block diagram showing a priority queuing approach according to the invention considering a priority of the output queues and a packet length using a weighted linear feedback shift register when output queues have 4 priority order levels.

Referring to FIG. 11, W1, W2 and W3, which are the outputs of the priority-weight allocating section 430, are applied to an AND operation with L1, L2 and L3, and the results of the AND operation are inputted to the priority encoder 410.

PL1, PL2 and PL3, which are control signals of the multiplexers, are related to the length of a packet to be transmitted in the first at the present time (cycle) in the output queues accorded the priority order levels 1, 2 and 3, respectively. For example, PL1, PL2 and PL3 may have two values ‘1’ or ‘0’. Specifically, PL1, PL2 and PL3 may have ‘0’ (or ‘1’) when the packet length is more than 1024 bytes, and ‘1’ (or ‘0’) when the packet length is less than 1024 bytes.

For example, the multiplexer 452 selects an upper input terminal thereof when the control signal, i.e., PL1, PL2 or PL3, is ‘1’, and the multiplexer 452 selects a lower input terminal thereof when the control signal, i.e., PL1, PL2 or PL3, is ‘0’.

L3 should be ‘1’ when W3 shown in FIG. 11 is ‘1’ in order that S3 is ‘1’. The probability for L3 to be ‘1’ is ¾ when the packet length is less than 1024 bytes, but ¼ when the packet length is more than 1024 bytes. Accordingly, the output queue selected by the output queue selecting signal (SEL) is selected in the probability proportional to the priority order and inversely proportional to the packet length.

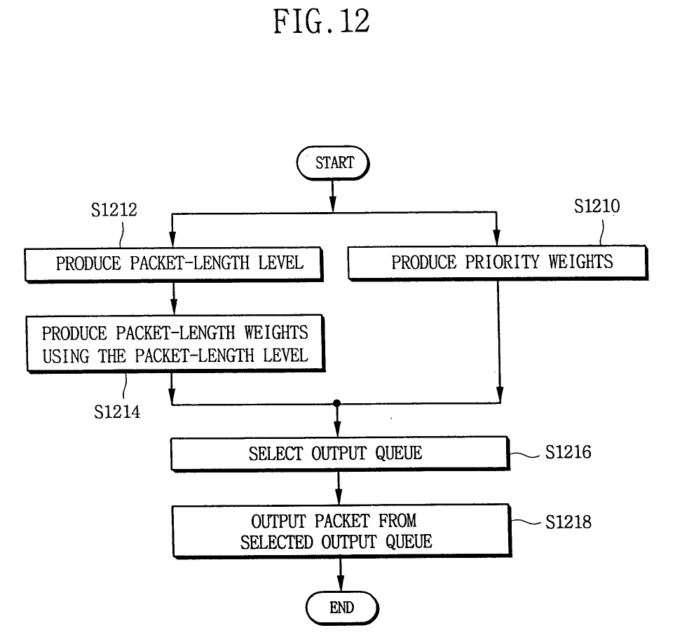

FIG. 12 is a flow chart illustrating a priority queuing approach using a weighted linear feedback shift register according to one exemplary embodiment of the present invention. Referring to FIG. 12, priority weights are produced based on the priority order of each of output queues (S1210). The priority weights have probability for selecting an output queue proportional to the priority order of the output queue.

Packet length information is extracted from headers of the packets stored in the output queues, and packet-length levels are produced (S1212). Packet-length weights are produced based on the packet-length levels such that the probability for selecting a packet is inversely proportional to the packet length (S1214).

An output queue is selected based on the priority weights and the packet-length weights (S1216), and a packet is outputted from the selected output queue (S1218).

The step (S1210) of producing the packet-length levels and the step (S1214) of producing the packet-length weights may be omitted, and the output queue may be selected based only on the priority weights.

The priority queuing apparatus and method according to the present invention can be applied to not only Ethernet switches but also to other network switches and routers in a packet-based communication system.

While this invention has been particularly shown and described with reference to preferred embodiments thereof, it will be understood by those skilled in the art that various changes in form and details may be made therein without departing from the spirit and scope of the invention as defined by the appended claims.

What is claimed is:

1. A priority queuing method comprising:
producing priority weights, each of the priority weights having a probability for selecting each of a plurality of output queues, and the probability corresponding to a priority order of each of the output queues;
selecting one of the output queues based on the priority weights; and
outputting a packet from the selected output queue.

2. The priority queuing method of claim 1, wherein the priority weights are produced by:
producing a pseudo-random bit stream; and
performing a logical operation by combining logical ‘0’ and ‘1’ bits of the pseudo-random bit stream.

3. The priority queuing method of claim 2, wherein each bit of the pseudo-random bit stream is a logical ‘1’ or ‘0’, and both ‘0’ and ‘1’ have a probability of ½.

4. The priority queuing method of claim 3, wherein each of the priority weights is produced by perform the logical operation by combining the logical 1’ or ‘0’ outputted from the pseudo-random bit stream such that each of the priority weights has a predetermined probability.

5. The priority queuing method of claim 4, wherein each of the priority weights has a probability of selecting each of the output queues, and the probability is proportional to the priority order of each of the output queues.

6. The priority queuing method of claim 1, wherein each of the priority weights has first and second probabilities for selecting each of the output queues, the first probability is a first probability value for the output queue having a first priority order and the second probability is a second probability value for the output queue having a second priority order, the first probability value being greater than the second probability value when the first priority order is higher than the second priority order.

7. The priority queuing method of claim 1, wherein the priority queuing method is performed in an Ethernet switch.

8. A priority queuing method comprising:
producing priority weights, each of the priority weights having a probability for selecting each of a plurality of output queues, and the probability corresponding to a priority order of each of the output queues;
producing a packet-length level based on packet length information of a packet stored in each of the output queues;
producing packet-length weights based on the packet-length level so as to increase a probability for selecting the packet, the probability being substantially inversely proportional to the packet length of the packet;
selecting one of the output queues by considering the priority order of each of the output queues and the packet length of the packet stored in each of the output queues based on the priority weights and the packet-length weights; and
outputting a packet from the selected output queue.

9. The priority queuing method of claim 8, wherein the priority weights are produced by:
producing a pseudo-random bit stream; and
performing a logical operation by combining logical ‘0’ and ‘1’ bits of the pseudo-random bit stream.

10. The priority queuing method of claim 9, wherein each bit of the pseudo-random bit stream is a logical ‘1’ or ‘0’, and both ‘0’ and ‘1’ have a probability of ½.

11. The priority queuing method of claim 10, wherein each of the priority weights is produced by performing the logical operation by combining logical ‘1’ and ‘0’ outputted form the pseudo-random bit stream such that each of the priority weights has a predetermined probability.

12. The priority queuing method of claim 8, wherein each of the priority weights has first and second probabilities for selecting each of the output queues, the first probability is a first probability value for the output queue having a first priority order and the second probability is a second probability value for the output queue having a second priority order, the first probability value being greater than the second probability value when the first priority order is higher than the second priority order.

13. The priority queuing method of claim 8, wherein the packet-length level is produced by dividing the packet length into a predetermined number of levels using packet length information of a binary bit stream.

14. The priority queuing method of claim 8, wherein each of the packet-length weight are produced by:
producing a pseudo-random bit stream;
performing a logical operation by combining logical ‘1’ and ‘0’ bits of the pseudo-random bit stream to produce weights, each of the weights having a predetermined value; and
producing the packet-length weights based on the weights and the packet-length levels, the packet-length weights having the probability for selecting the output queues, the probability being inversely proportional to the packet length.

15. The priority queuing method of claim 8, wherein the packet-length level is produced by dividing the packet length into a predetermined number of levels, and the number of the levels is the same as a number of priority order levels.

16. The priority queuing method of claim 8, wherein a number of the priority weights and a number of the packet-length weights are the same as a number of priority order levels of the output queues.

17. The priority queuing method of claim 8, wherein the priority queuing method is performed in an Ethernet switch.

18. A priority queuing apparatus for selecting one of priority queues based on a priority order of each of the output queues, the apparatus comprising:
a priority-weight allocating section for producing priority weights, each of the priority weights having a probability for selecting each of a plurality of output queues, and the probability corresponding to a priority order of each of output queues;
an output queue selecting section for generating an output-queue selecting signal for selecting one of the output queues based on the priority weights; and
a packet outputting section for outputting a packet from the output queue selected by using the output-queue selecting signal.

19. The priority queuing apparatus of claim 18, wherein the priority-weight allocating section performs a logical operation on a plurality of outputs of a linear feedback shift register so as to produce the priority weights having a random probability value.

20. The priority queuing apparatus of claim 18, wherein the priority-weight allocating section produces the priority weights based on the priority order of each of the output queues, each of the priority weights has a probability of selecting each of the output queues, and the probability is proportional to the priority order of each of the output queues.

21. A priority queuing apparatus for selecting one of priority queues based on a priority order of each of the output queues, the apparatus comprising:
a priority-weight allocating section for producing priority weights, each of the priority weights having a probability for selecting each of a plurality of output queues, and the probability corresponding to a priority order of each of the output queues;
a packet-length level calculating section for producing a packet-length level based on packet length information of a packet stored in each of the output queues;
a packet-length weight allocating section for producing packet-length weights based on the packet-length level so as to increase a probability for selecting the packet, and the probability being substantially inversely proportional to a packet length of the packet;
an output queue selecting section for generating an output-queue selecting signal for selecting one of the output queues in correspondence to the priority order of each of the output queues and the packet length of the packet stored in each of the output queues based on the priority weights and the packet-length weights; and
a packet outputting section for outputting a packet from the output queue selected by using the output-queue selecting signal.

22. A priority queuing apparatus of claim 21, wherein the priority-length weight allocating section performs a logical operation on a plurality of outputs of a linear feedback shift register to produce a plurality of first weights having a random probability and produces the packet-length weight.
